(19) United States
(12) Patent Application Publication
(10) Pub. No.: US 2025/0334141 A1
(43) Pub. Date: Oct. 30, 2025

(54) ROTARY LOCKING DEVICE

(71) Applicant: STEP2GOLD CO., LTD., Taichung City (TW)

(72) Inventor: Chih-Ting PAO, Taichung City (TW)

(21) Appl. No.: 18/986,787

(22) Filed: Dec. 19, 2024

(30) Foreign Application Priority Data
Apr. 29, 2024 (TW) 113204314

(51) Int. Cl. F16B 7/20; F16B 21/04

(52) U.S. Cl. CPC F16B 7/20; F16B 21/04

(57) ABSTRACT

A rotary locking device includes a tube unit, a positioning seat unit, and a locking unit. The tube unit has a tube outer circumferential surface that is formed with at least one axial guide groove extending along an axial direction. The positioning seat unit is disposed on the tube unit, and has a positioning seat outer circumferential surface that is formed with at least one positioning groove. The at least one positioning groove has an inlet groove portion that opens downwardly, and a circumferential groove portion that communicates with the inlet groove portion. The locking unit is movable relative to the tube unit in the axial direction, and includes a sliding seat that is sleeved on the tube unit, a rotary seat that is rotatably disposed on the sliding seat, and at least one resilient member that is disposed between the sliding seat and the rotary seat.

### CROSS-REFERENCE TO RELATED APPLICATION

This application claims priority to Taiwanese Utility Model Patent application Ser. No. 11/320,4314, filed on Apr. 29, 2024, the entire disclosure of which is incorporated by reference herein.

### FIELD

The disclosure relates to a locking device, and more particularly to a rotary locking device that can be used in a crutch chair.

### BACKGROUND

As shown in FIGS. 1, 2, and 3, a conventional foldable chair

having a lock structure (Taiwanese Invention Patent No. I520695) includes a support unit 1, a folding unit 2 that is movably disposed on the support unit 1, and a seat unit 3 that is disposed between the support unit 1 and the folding unit 2. The support unit 1 includes a mounting rod 101 that is formed with a recessed rail 102, an upper engaging groove 103 that communicates with the recessed rail 102, and a lower engaging groove 104 that communicates with the recessed rail 102. The folding unit 2 includes an upper slide seat 201 that is sleeved on the mounting rod 101, a cap body 202 that is rotatably disposed on the upper slide seat 201, and two positioning resilient members 203 that are disposed between the upper slide seat 201 and the cap body 202. The upper slide seat 201 is formed with a sliding groove 204. The cap body 202 includes an engaging block 205 that extends through the sliding groove 204 and that is operable to engage the recessed rail 102.

When the engaging block 205 engages the lower engaging groove 104, the seat unit 3 is unfolded. Afterward, as shown in FIGS. 2, 3, and 4, when the seat unit 3 is to be folded by a user, the cap body 202 is first rotated counterclockwise (viewed from above the conventional foldable chair) so that the engaging block 205 is separated from the lower engaging groove 104 and engages the recessed rail 102. Next, the cap body 202 is moved upwardly to urge the upper slide seat 201 to move upwardly until the sliding groove 204 is aligned with the upper engaging groove 103. Next, when the cap body 202 is released by the user, the positioning resilient members 203 urge the cap body 202 to rotate clockwise (viewed from above the conventional foldable chair) such that the engaging block 205 is separated from the recessed rail 102 and engages the upper engaging groove 103. Consequently, the seat unit 3 is maintained in a folded state.

Although the conventional foldable chair having the lock structure is operable to be folded or unfolded, it is still desirable to provide a greater selection of lock structures to customers.

### SUMMARY

Therefore, an object of the disclosure is to provide a rotary locking device having a configuration different from the abovementioned prior art.

According to the disclosure, the rotary locking device includes a tube unit, a positioning seat unit, and a locking unit. The tube unit has a tube outer circumferential surface. The tube outer circumferential surface is formed with at least one axial guide groove that extends along an axial direction, and at least one first transverse guide groove that communicates with the at least one axial guide groove. The positioning seat unit is disposed on the tube unit, and has a positioning seat outer circumferential surface. The positioning seat outer circumferential surface is formed with at least one positioning groove. The at least one positioning groove has an inlet groove portion that opens downwardly, and a circumferential groove portion that communicates with the inlet groove portion. The positioning seat outer circumferential surface has at least one guide inclined surface portion that defines a lateral side of the inlet groove portion of the at least one positioning groove which faces the circumferential groove portion. The locking unit is disposed on the tube unit, is movable relative to the tube unit in the axial direction, and includes a sliding seat that is sleeved on the tube unit, a rotary seat that is rotatably disposed on the sliding seat, and at least one resilient member that is disposed between the sliding seat and the rotary seat. The sliding seat has at least one guide block that engages the at least one axial guide groove, and at least one sliding seat transverse guide groove. The rotary seat includes at least one guiding slide block and at least one locking block. The at least one guiding slide block extends through the at least one sliding seat transverse guide groove, and is operable to engage the at least one axial guide groove. The at least one locking block has a driven portion and a positioning portion. The locking unit is movable relative to the tube unit between a free position and a working position. When the locking unit is in the free position, the at least one sliding seat transverse guide groove is spaced apart from the at least one first transverse guide groove in the axial direction, the at least one guiding slide block engages the at least one axial guide groove, and the at least one locking block is separated from the at least one positioning groove. When the locking unit is in the working position, the at least one sliding seat transverse guide groove is aligned with the at least one first transverse guide groove, the at least one guiding slide block engages the at least one first transverse guide groove, the at least one locking block enters the at least one positioning groove, and the rotary seat is rotatable relative to the sliding seat between an unlocked position and a locked position. When the rotary seat is in the unlocked position, the driven portion of the at least one locking block is in the inlet groove portion of the at least one positioning groove and is in contact with the at least one guide inclined surface portion of the positioning seat outer circumferential surface, and the positioning portion of the at least one locking block is separated from the circumferential groove portion of the at least one positioning groove and corresponds in position to the inlet groove portion of the at least one positioning groove. When the rotary seat is in the locked position, the driven portion of the at least one locking block is in the inlet groove portion of the at least one positioning groove and is separated from the at least one guide inclined surface portion of the positioning seat outer circumferential surface, and the positioning portion of the at least one locking block engages the circumferential groove portion of the at least one positioning groove. The resilient member resiliently biases the rotary seat toward the locked position.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view of a conventional foldable chair having a lock structure.

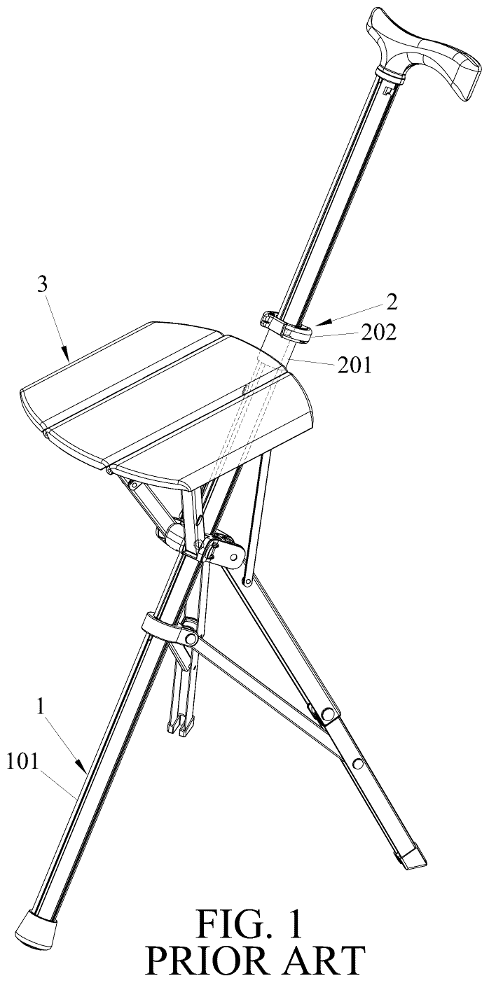

FIG. 2 is a fragmentary, partly exploded perspective view of the conventional foldable chair.

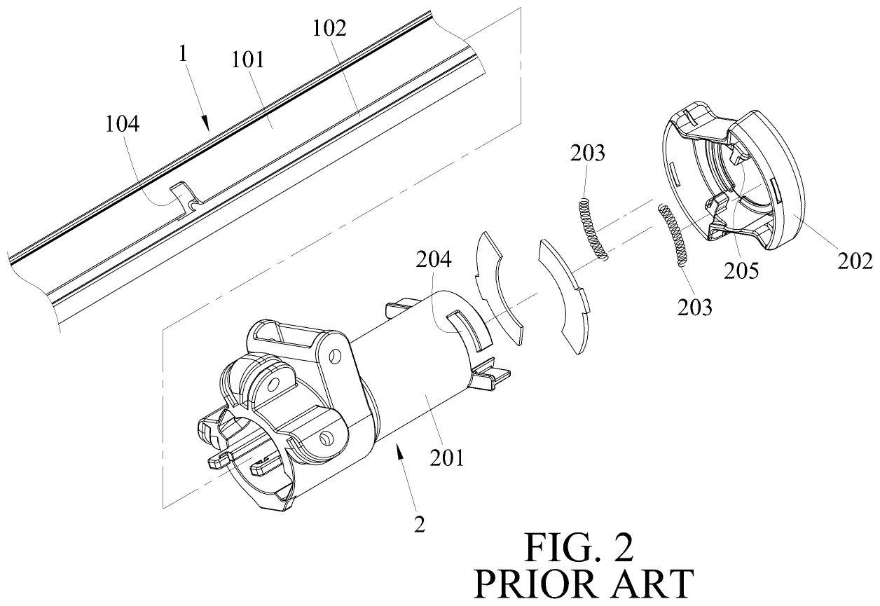

FIG. 3 is a fragmentary perspective view of the conventional foldable chair.

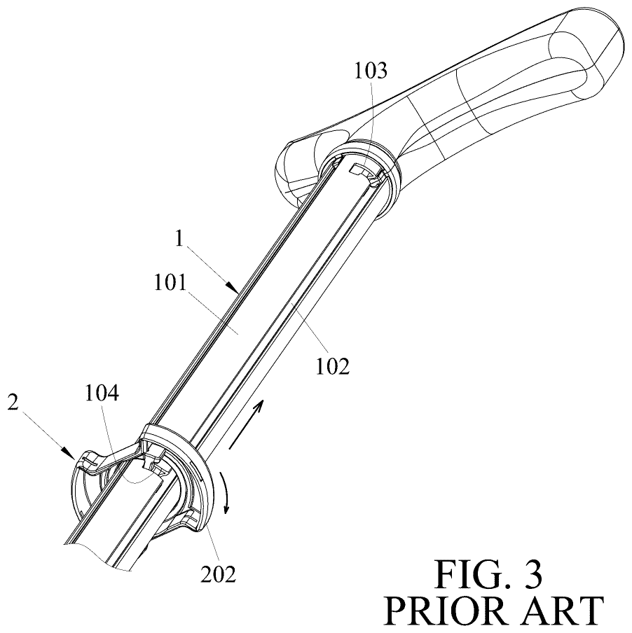

FIG. 4 is a view similar to FIG. 3, but illustrating a cap body of the conventional foldable chair engaging an upper engaging groove of a mounting rod of the conventional foldable chair.

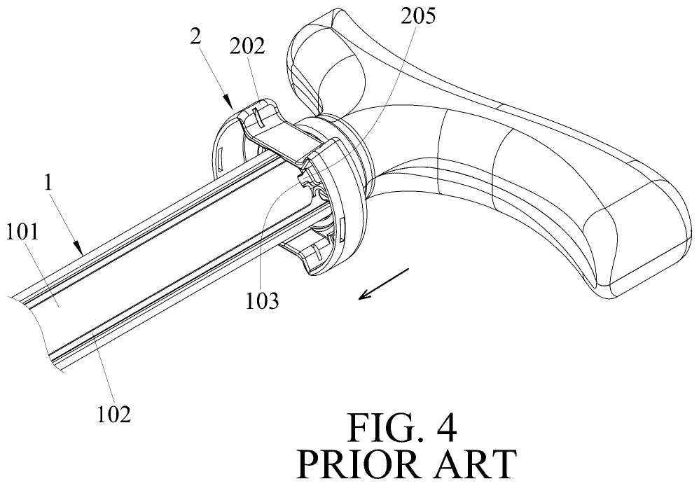

FIG. 5 is a fragmentary perspective view of an embodiment of a rotary locking device according to the disclosure.

FIG. 6 is a fragmentary, exploded perspective view of the embodiment.

FIG. 7 is a front view of a positioning seat unit of the embodiment.

FIG. 8 is a perspective view of a rotary seat of a locking unit of the embodiment.

FIG. 9 is a fragmentary sectional view of the embodiment, illustrating the locking unit in a free position.

FIG. 10 is a sectional view taken along line X-X in FIG. 9.

FIG. 11 is a fragmentary front view of the embodiment, illustrating the locking unit in a working position and the rotary seat in an unlocked position.

FIG. 12 is a sectional view taken along line XII-XII in FIG. 11.

FIG. 13 is a fragmentary sectional view taken along line XIII-XIII in p FIG. 12.

FIG. 14 is a sectional view taken along line XIV-XIV in FIG. 11.

FIG. 15 is a view similar to FIG. 11, but illustrating the rotary seat being rotated toward a locked position.

FIG. 16 is a sectional view taken along line XVI-XVI in FIG. 15.

FIG. 17 is a fragmentary sectional view taken along line XVII-XVII in FIG. 16.

FIG. 18 is a sectional view taken along line XVIII-XVIII in FIG. 15.

FIG. 19 is a view similar to FIG. 11, but illustrating the rotary seat in the locking position.

FIG. 20 is a sectional view taken along line XX-XX in FIG. 19.

FIG. 21 is a fragmentary sectional view taken along line XXI-XXI in FIG. 20.

FIG. 22 is a sectional view taken along line XXII-XXII in FIG. 19.

### DETAILED DESCRIPTION

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

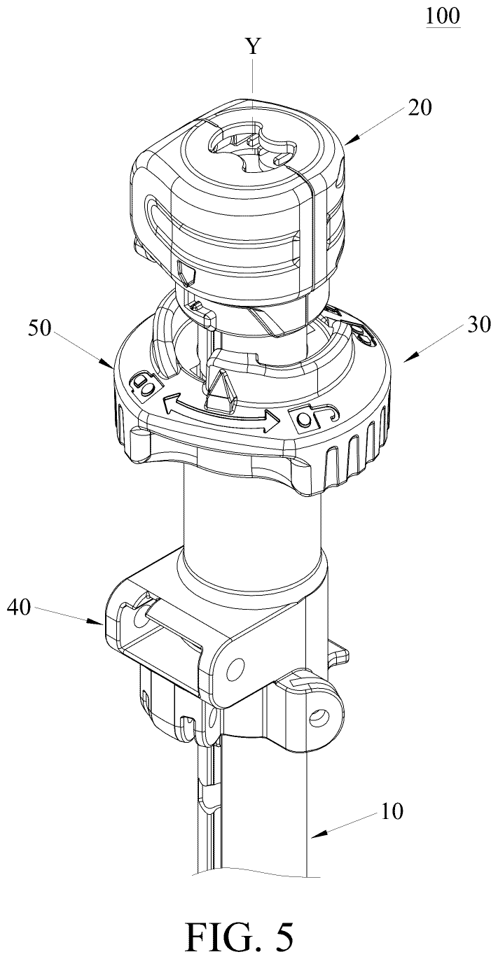

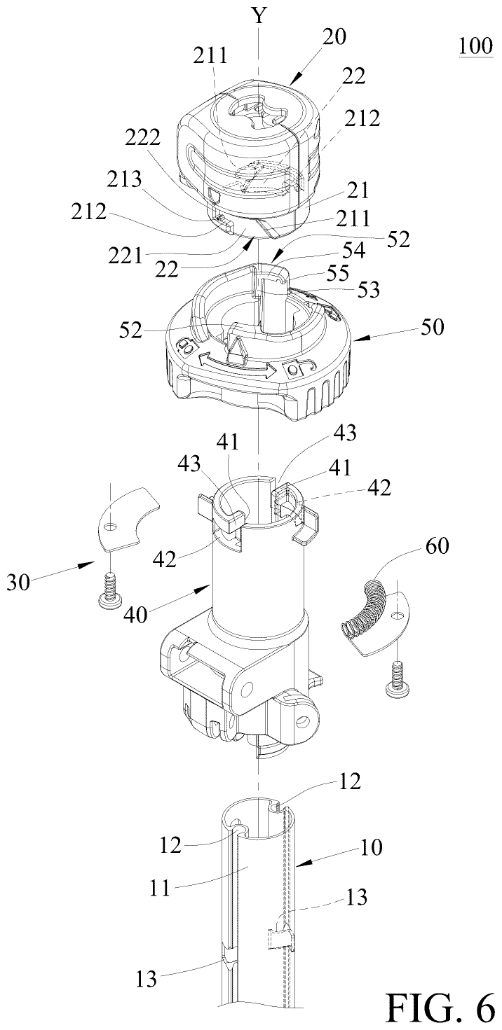

Referring to FIGS. 5 and 6, an embodiment of a rotary locking device 100 according to the present disclosure includes a tube unit 10, a positioning seat unit 20, and a locking unit 30. In the embodiment, the rotary locking device 100 may be, but not limited to be, used in a crutch chair that is similar to the abovementioned conventional foldable chair.

The tube unit 10 has a tube outer peripheral surface 11 that is formed with two opposite axial guide grooves 12 which extend along an axial direction (Y), and two first transverse guide grooves 13 which respectively communicate with the axial guide grooves 12.

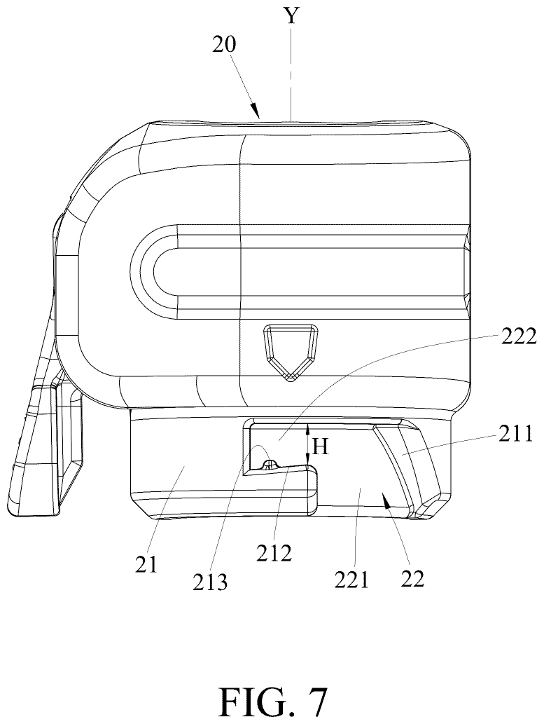

As shown in FIGS. 6 and 7, the positioning seat unit 20 is disposed on the tube unit 10, and has a positioning seat outer circumferential surface 21 that is formed with two opposite positioning grooves 22 which are antisymmetric. Each of the positioning grooves 22 has an inlet groove portion 221 that opens downwardly, and a circumferential groove portion 222 that communicates with the inlet groove portion 221.

In this embodiment, the positioning seat outer circumferential surface 21 has two guide inclined surface portions 211 and two groove bottom surface portions 212. Each of the guide inclined surface portions 211 defines a lateral side of the inlet groove portion 221 of a respective one of the positioning grooves 22 that faces the circumferential groove portion 222 of the positioning groove 22. Each of the groove bottom surface portions 212 defines a bottom side of the circumferential groove portion 222 of a respective one of the positioning grooves 22. Each of the groove bottom surface portions 212 is inclined downwardly away from the inlet groove portion 221 of the respective one of the positioning grooves 22, and each of the groove bottom surface portions 212 has a positioning protruding block 213.

In this embodiment, the circumferential groove portion 222 of each of the positioning grooves 22 has a minimum opening height (H) in the axial direction (Y).

As shown in FIG. 6, the locking unit 30 is movably disposed on the tube unit 10, is movable relative to the tube unit 10 in the axial direction (Y), and includes a sliding seat 40 that is sleeved on the tube unit 10, a rotary seat 50 that is rotatably disposed on the sliding seat 40, and a resilient member 60 that is disposed between the sliding seat 40 and the rotary seat 50.

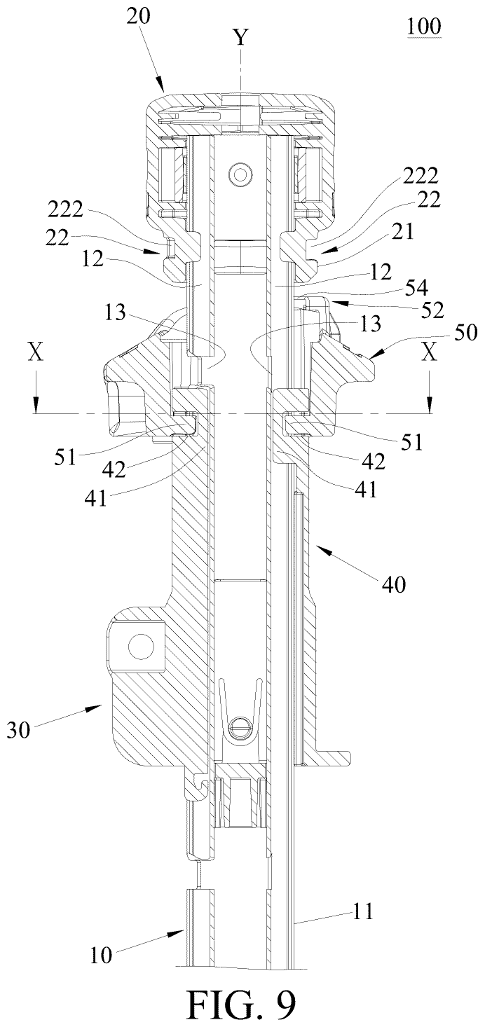

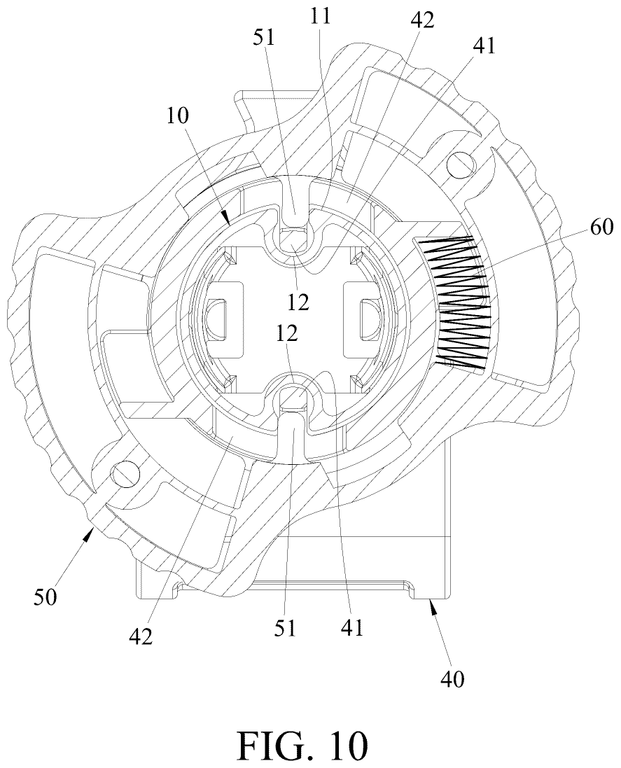

As shown in FIGS. 6, 9, and 10, the sliding seat 40 has two guide blocks 41 that respectively engage the axial guide grooves 12, two opposite sliding seat transverse guide grooves 42 that are antisymmetric, and two sliding block passages 43 that respectively communicate with the sliding seat transverse guide grooves 42 and that extend in the axial direction (Y).

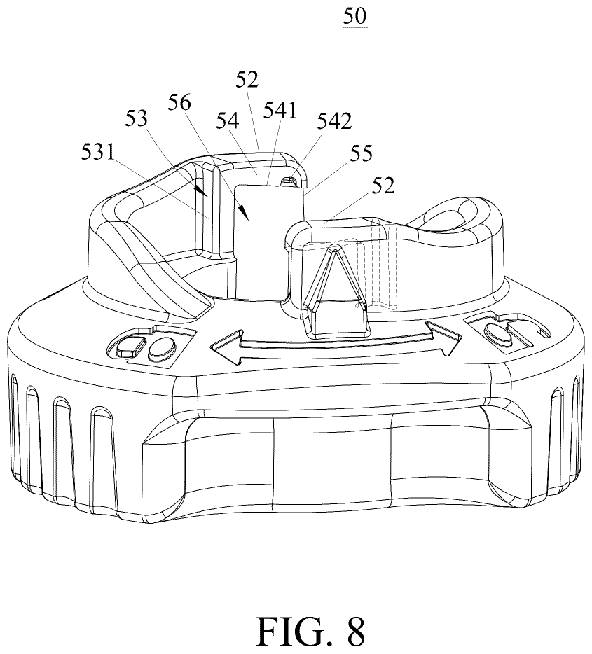

As shown in FIGS. 8, 9, and 10, the rotary seat 50 includes two opposite guiding slide blocks 51, and two opposite locking blocks 52 that are antisymmetric.

Each of the guiding slide blocks 51 extends through a respective one of the sliding seat transverse guide grooves 42, and is operable to engage a respective one of the axial guide grooves 12.

In this embodiment, each of the locking blocks 52 includes a driven portion 53, a positioning portion 54, and an outer wall portion 55 that is connected to the positioning portion 54 and the driven portion 53. For each of the locking blocks 52, the positioning portion 54 cooperates with the driven portion 53 and the outer wall portion 55 to define a clearance space 56.

In this embodiment, the driven portion 53 of each of the locking blocks 52 has a driven surface 531 that extends along the axial direction (Y). The positioning portion 54 of each of the locking blocks 52 extends circumferentially from a top end of the driven portion 53 of the locking block 52. The positioning portion 54 of each of the locking blocks 52 has a positioning bottom surface 541 that is formed with a positioning slot 542. An inclination of the positioning bottom surface 541 of the positioning portion 54 of each of the locking blocks 52 matches an inclination of a respective one of the groove bottom surface portions 212.

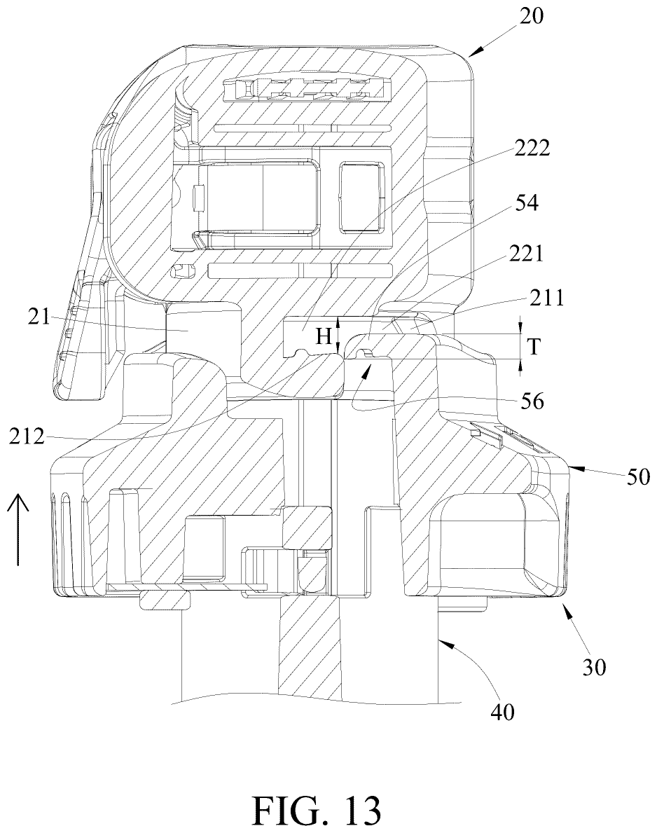

In this embodiment, the positioning portion 54 of each of the locking blocks 52 has a maximum thickness (T) (see FIG. 13) in the axial direction (Y) that is less than the minimum opening height (H) (see FIG. 13) of the circumferential groove portion 222 of a respective one of the positioning grooves 22.

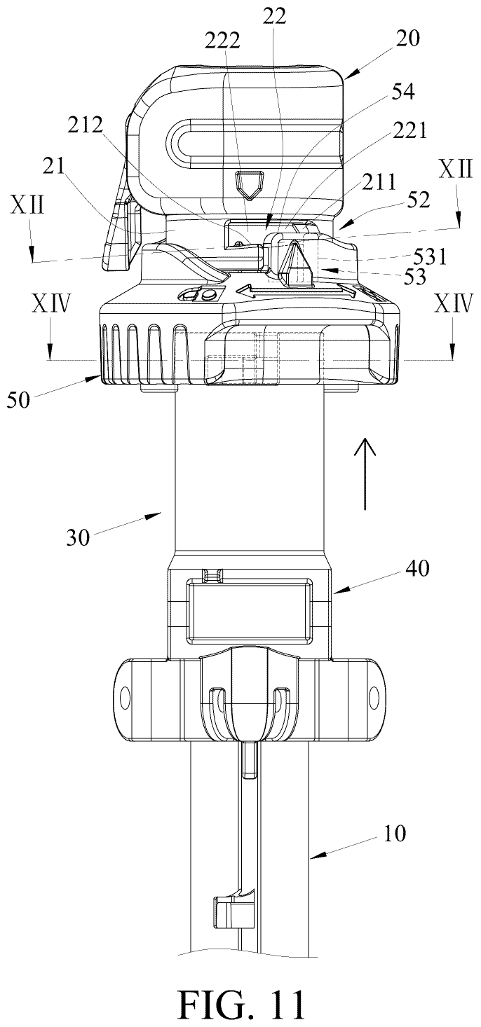

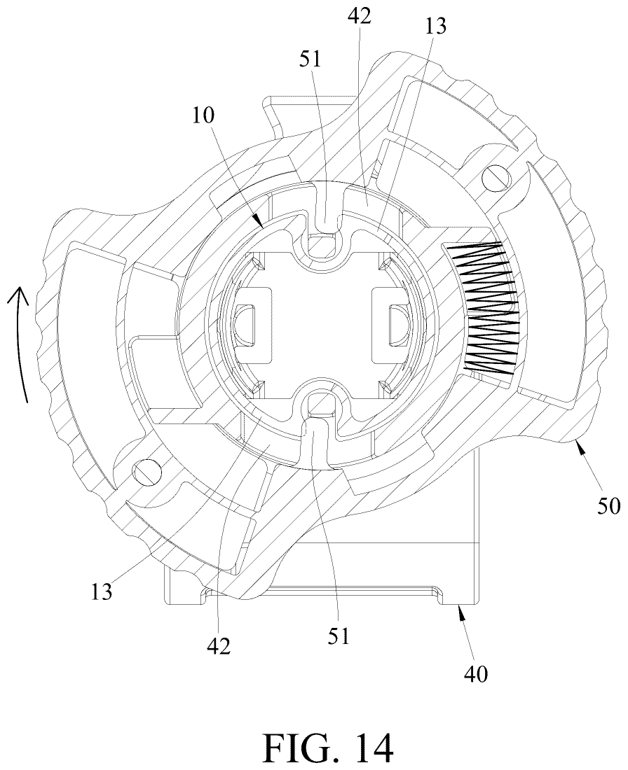

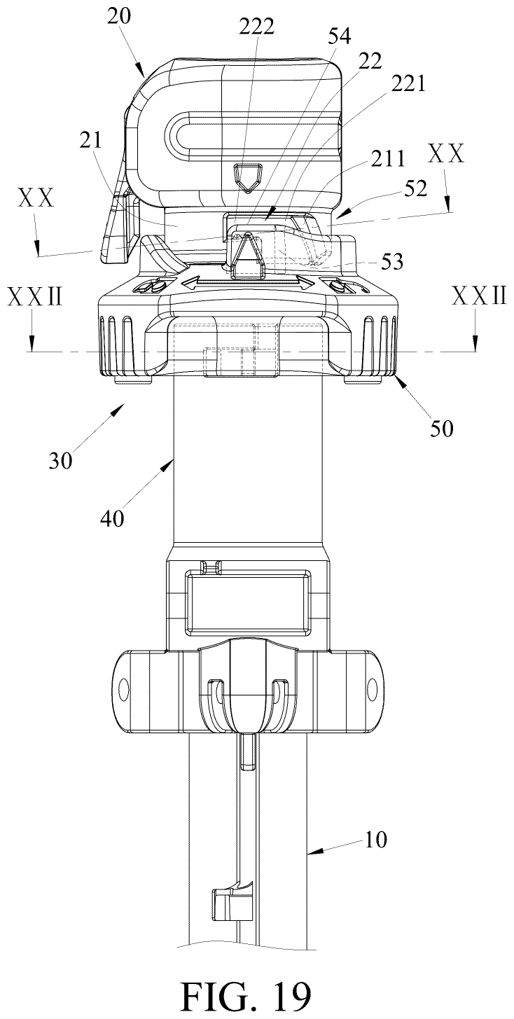

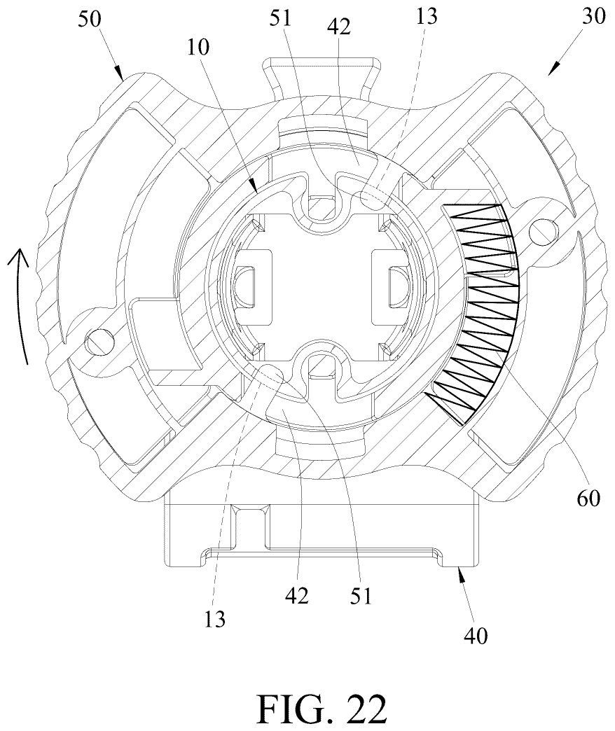

The locking unit 30 is movable relative to the tube unit 10 between a free position (see FIGS. 5, 9, and 10) and a working position (see FIGS. 11 and 14, or FIGS. 19 and 22). Referring to FIGS. 5, 9, and 10, when the locking unit 30 is in the free position, each of the sliding seat transverse guide grooves 42 is spaced apart from a respective one of the first transverse guide grooves 13 in the axial direction (Y), each of the guiding slide blocks 51 engages the respective one of the axial guide grooves 12, and each of the locking blocks 52 is separated from the respective one of the positioning grooves 22. As shown in FIGS. 11 and 14, or FIGS. 19 and 22, when the locking unit 30 is in the working position, each of the sliding seat transverse guide grooves 42 is aligned with the respective one of the first transverse guide grooves 13 in a radial direction of the tube unit, each of the guiding slide blocks 51 engages a respective one of the first transverse guide grooves 13, and each of the locking blocks 52 enters the respective one of the positioning grooves 22.

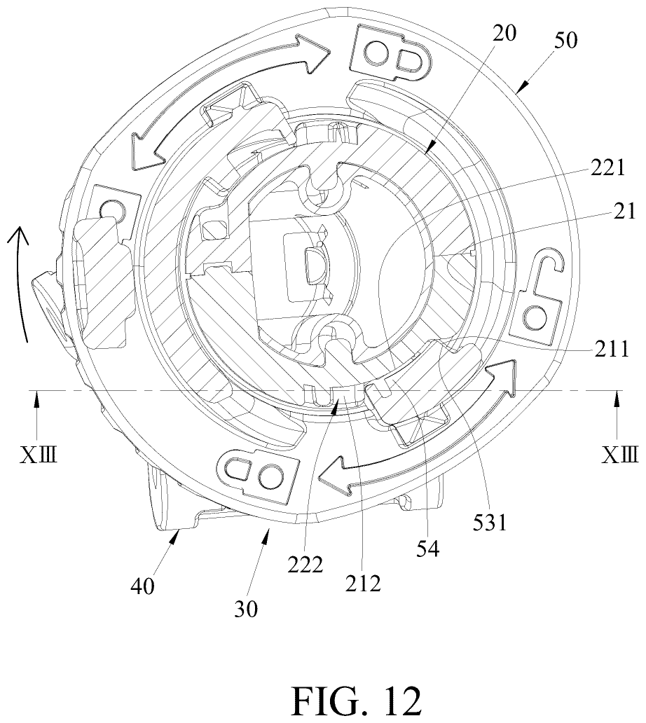

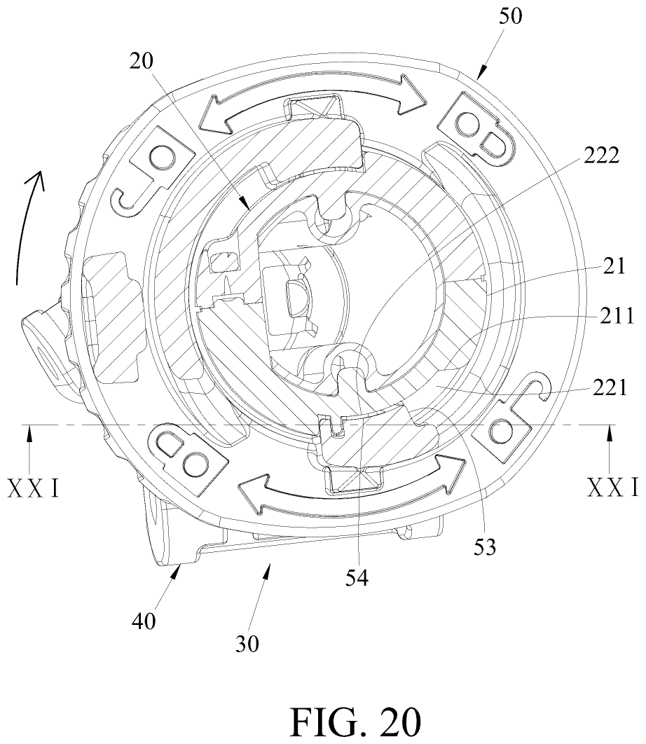

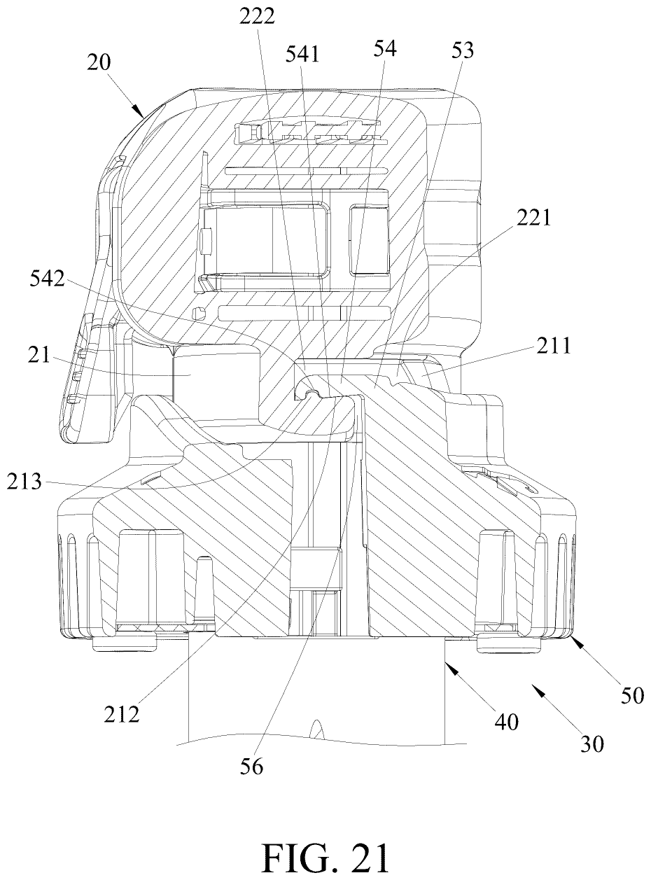

When the locking unit 30 is in the working position (see FIGS. 11 and 14, or FIGS. 19 and 22), the rotary seat 50 is rotatable relative to the sliding seat 40 between an unlocked position (see FIGS. 11, 12, and 13) and a locked position (see FIGS. 19, 20, and 21). The resilient member 60 (see FIG. 22) resiliently biases the rotary seat 50 toward the locking position.

As shown in FIGS. 11, 12, and 13, when the locking unit 30 is in the working position and when the rotary seat 50 is in the unlocked position, the driven portion 53 of each of the locking blocks 52 is in the inlet groove portion 221 of the respective one of the positioning grooves 22, the driven surface 531 of the driven portion 53 of each of the locking blocks 52 is in contact with the respective one of the guide inclined surface portions 211, the positioning portion 54 of each of the locking blocks 52 is separated from the circumferential groove portion 222 of the respective one of the positioning grooves 22 and corresponds in position to the inlet groove portion 221 of the respective one of the positioning grooves 22, and each of the groove bottom surface portions 212 of the positioning seat outer peripheral surface 21 is located outside the clearance space 56 of the respective one of the locking blocks 52.

As shown in FIGS. 19, 20, and 21, when the locking unit 30 is in the working position and when the rotary seat 50 is in the locked position, the driven portion 53 of each of the locking blocks 52 is in the inlet groove portion 221 of the respective one of the positioning grooves 22 and is separated from the respective one of the guide inclined surface portions 211, the positioning portion 54 of each of the locking blocks 52 engages the circumferential groove portion 222 of the respective one of the positioning grooves 22, the positioning bottom surface 541 of the positioning portion 54 of each of the locking blocks 52 abuts against the respective one of the groove bottom surface portion 212, the positioning protruding block 213 of each of the groove bottom surface portions 212 is coupled to the positioning slot 542 of the positioning bottom surface 541 of the positioning portion 54 of the respective one of the locking blocks 52, each of the groove bottom surface portions 212 of the positioning seat outer peripheral surface 21 of the positioning seat unit 20 is located in the clearance space 56 of the respective one of the locking blocks 52.

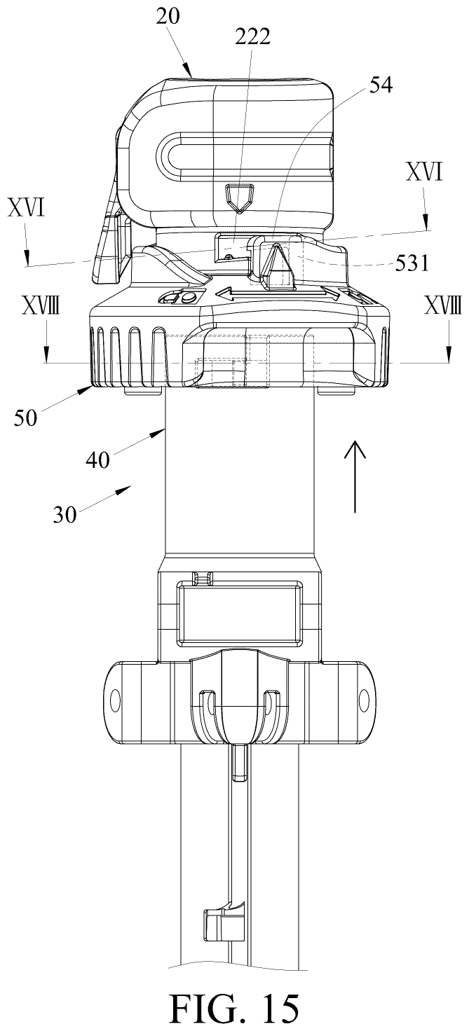

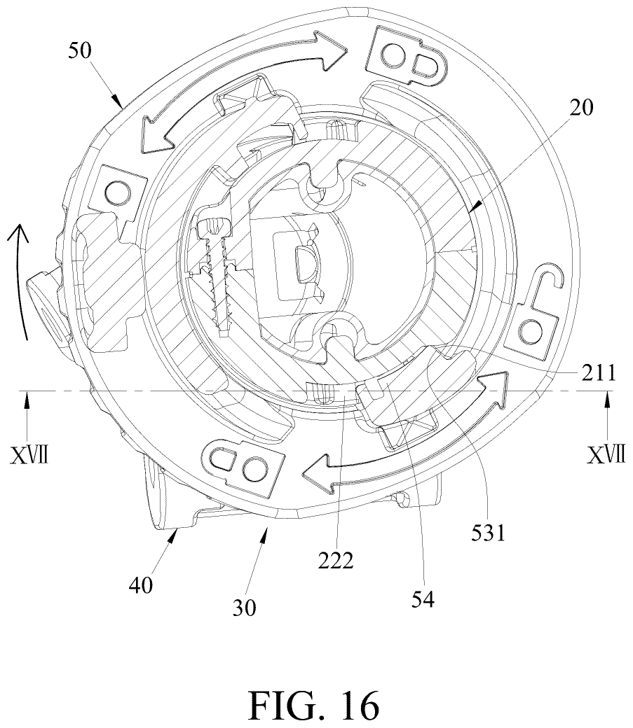

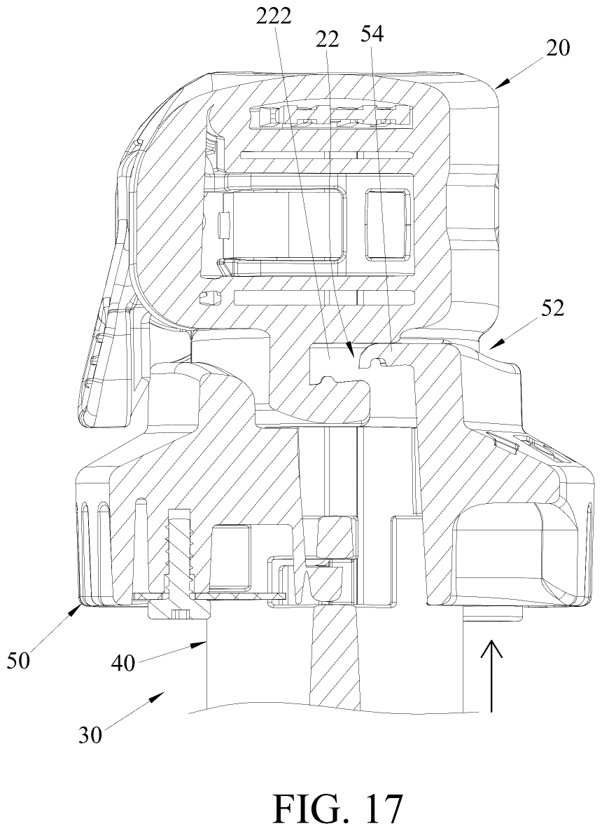

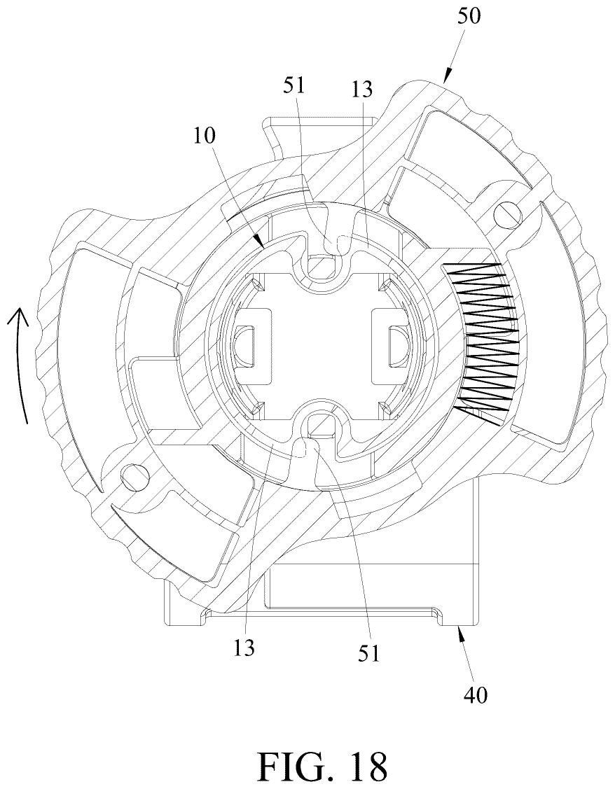

As shown in FIGS. 11, 12, and 13, when the rotary locking device 100 is used in a crutch chair (not shown) that is similar to the abovementioned conventional foldable chair, the sliding seat 40 is adapted to be connected to a seat unit (not shown) of the crutch chair so that a user may urge the locking unit 30 to move from the free position (see FIGS. 5, 9, and 10) toward the working position when the user wants to securely fold the seat unit of the crutch chair. In this process, the driven surface 531 of the driven portion 53 of each of the locking blocks 52 is urged to come into contact with the respective one of the guide inclined surface portions 211 such that the rotary seat 50 is urged to rotate in a clockwise direction (viewed from above the rotary locking device 100) and that the positioning portion 54 of each of the locking blocks 52 is rotated to be adjacent to an open edge of the circumference groove portion 222 of the respective one of the positioning grooves 22. At this time, the rotary seat 50 is in the unlocked position. Furthermore, referring to FIG. 14, each of the guiding slide blocks 51 of the rotary seat 50 enters the respective one of the first transverse guide grooves 13 of the tube unit 10. Next, as shown in FIGS. 15, 16, and 17, when the user continues to urge the locking unit 30 to move upwardly, the driven surface 531 of the driven portion 53 of each of the locking blocks 52 moves along the respective one of the guide inclined surface portions 211 (i.e., the driven surface 531 of the driven portion 53 of each of the locking blocks 52 is pushed by the respective one of the guide inclined surface portions 211) such that the rotary seat 50 is urged to further rotate in the clockwise direction (viewed from above the rotary locking device 100) and that the positioning portion 54 of each of the locking blocks 52 is urged to enter the circumferential groove portion 222 of the respective one of the positioning grooves 22 by rotation of the rotary seat 50. At this time, referring to FIG. 18, each of the guiding slide blocks 51 of the rotary seat 50 moves along the respective one of the first transverse guide grooves 13 of the tube unit 10. Then, as shown in FIGS. 19, 20, and 21, when the user releases the rotary seat 50, the resilient member 60 (see FIG. 22) resiliently biases the rotary seat 50 such that the rotary seat 50 rotates in the clockwise direction to the locking position and that the positioning portion 54 of each of the locking blocks 52 engages the circumferential groove portion 222 of the respective one of the positioning grooves 22. During the clockwise rotation of the rotary seat 50, the rotary seat 50 falls on the groove bottom surface portions 212 due to gravity such that the positioning bottom surface 541 of the positioning portion 54 of each of the locking blocks 52 abuts against the respective one of the groove bottom surface portions 212 and that the positioning protruding block 213 of each of the groove bottom surface portions 212 is coupled to the positioning slot 542 of the positioning portion 54 of the respective one of the locking blocks 52. At this time, referring to FIG. 22, each of the guiding slide blocks 51 of the rotary seat 50 is moved to one end of the respective one of the first transverse guide grooves 13 that is distal from the respective one of the axial guide grooves 12. Consequently, the rotary seat 50 is positioned in the locked position so that the seat unit of the crutch chair is securely folded and may not be unfolded by accident.

Through the above description, the advantages of the rotary locking device 100 are summarized as follows.

By virtue of the positioning grooves 22 of the positioning seat unit 20 cooperating with the locking blocks 52 of the rotary seat 50 and the resilient member 60, when the user urges the locking unit 30 to move upwardly to the working position, the driven portion 53 of each of the locking blocks 52 comes into contact with the respective one of the guide inclined surface portions 211 so that the rotary seat 50 is forced to synchronously rotate toward the locked position, and that the positioning portion 54 of each of the locking blocks 52 is guided into the circumferential groove portion 222 of the respective one of the positioning grooves 22. Hence, even if the user does not rotate the rotary seat 50 by hand and just lets go of the rotary seat 50, the rotary seat 50 may still smoothly and successfully rotate to the locked position and be positioned in the locked position by a restoring force provided by the resilient member 60. The rotary locking device 100 may effectively prevent the seat unit of the crutch chair from being unfolded by accident. As such, the user may not need to fold the seat unit again because accidental failure of folding the seat unit is prevented, and the user is further prevented from injury caused by the seat unit that is unfolded by accident.

In summary, the rotary seat 50 is rotated to the locked position and positioned in the locked position by the restoring force of the resilient member 60, so the rotary locking device 100 allows the user to let go of the rotary seat 50 when the locking unit 30 is in the working position (i.e., the rotary seat 50 may be rotated without manual operation when the locking unit 30 is in the working position). Moreover, the seat unit of the crutch chair that adopts the rotary locking device 100 is prevented from being unfolded by accident, and the rotary locking device 100 has a configuration different from the abovementioned prior art, so the purpose of the present disclosure may indeed be achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A rotary locking device, comprising:
a tube unit having a tube outer circumferential surface, the tube outer circumferential surface being formed with at least one axial guide groove that extends along an axial direction, and at least one first transverse guide groove that communicates with the at least one axial guide groove;
a positioning seat unit disposed on the tube unit and having a positioning seat outer circumferential surface, the positioning seat outer circumferential surface being formed with at least one positioning groove, the at least one positioning groove having an inlet groove portion that opens downwardly, and a circumferential groove portion that communicates with the inlet groove portion, the positioning seat outer circumferential surface having at least one guide inclined surface portion that defines a lateral side of the inlet groove portion of the at least one positioning groove which faces the circumferential groove portion; and
a locking unit disposed on the tube unit, movable relative to the tube unit in the axial direction, and including a sliding seat that is sleeved on the tube unit, a rotary seat that is rotatably disposed on the sliding seat, and at least one resilient member that is disposed between the sliding seat and the rotary seat, the sliding seat having at least one guide block that engages the at least one axial guide groove, and at least one sliding seat transverse guide groove, the rotary seat including at least one guiding slide block and at least one locking block, the at least one guiding slide block extending through the at least one sliding seat transverse guide groove, and being operable to engage the at least one axial guide groove, the at least one locking block having a driven portion and a positioning portion, the locking unit being movable relative to the tube unit between a free position and a working position;
wherein, when the locking unit is in the free position, the at least one sliding seat transverse guide groove is spaced apart from the at least one first transverse guide groove in the axial direction, the at least one guiding slide block engages the at least one axial guide groove, and the at least one locking block is separated from the at least one positioning groove;
wherein, when the locking unit is in the working position, the at least one sliding seat transverse guide groove is aligned with the at least one first transverse guide groove, the at least one guiding slide block engages the at least one first transverse guide groove, the at least one locking block enters the at least one positioning groove, and the rotary seat is rotatable relative to the sliding seat between an unlocked position and a locked position;
wherein, when the rotary seat is in the unlocked position, the driven portion of the at least one locking block is in the inlet groove portion of the at least one positioning groove and is in contact with the at least one guide inclined surface portion of the positioning seat outer circumferential surface, and the positioning portion of the at least one locking block is separated from the circumferential groove portion of the at least one positioning groove and corresponds in position to the inlet groove portion of the at least one positioning groove;
wherein, when the rotary seat is in the locked position, the driven portion of the at least one locking block is in the inlet groove portion of the at least one positioning groove and is separated from the at least one guide inclined surface portion of the positioning seat outer circumferential surface, and the positioning portion of the at least one locking block engages the circumferential groove portion of the at least one positioning groove; and
wherein the resilient member resiliently biases the rotary seat toward the locked position.

2. The rotary locking device as claimed in claim 1, wherein the positioning seat outer peripheral surface of the positioning seat unit further has at least one groove bottom surface portion that defines a bottom side of the circumferential groove portion of the at least one positioning groove, the at least one groove bottom surface portion being inclined downwardly away from the inlet groove portion of the at least one positioning groove, the positioning portion of the at least one locking block of the rotary seat having a positioning bottom surface, an inclination of the positioning bottom surface of the at least one locking block matching an inclination of the at least one groove bottom surface portion, the positioning bottom surface of the at least one locking block abutting against the at least one groove bottom surface portion when the locking unit is in the working position and when the rotary seat is in the locked position.

3. The rotary locking device as claimed in claim 2, wherein the at least one groove bottom surface portion of the positioning seat outer peripheral surface of the positioning seat unit has a positioning protruding block, the positioning bottom surface of the positioning portion of the at least one locking block of the rotary seat being formed with a positioning slot, the positioning protruding block being coupled to the positioning slot when the locking unit is in the working position and when the rotary seat is in the locked position.

4. The rotary locking device as claimed in claim 2, wherein the circumferential groove portion of the at least one positioning groove of the positioning seat unit has a minimum opening height in the axial direction, the positioning portion of the at least one locking block of the rotary seat having a maximum thickness in the axial direction that is less than the minimum opening height.

5. The rotary locking device as claimed in claim 2, wherein the at least one locking block of the rotary seat further has an outer wall portion that is connected to the positioning portion and the driven portion, the positioning portion cooperating with the driven portion and the outer wall portion to define a clearance space, the at least one groove bottom surface portion of the positioning seat outer peripheral surface of the positioning seat unit being located outside the clearance space of the at least one locking blocks when the locking unit is in the working position and when the rotary seat is in the unlocked position, the at least one groove bottom surface portion of the positioning seat outer peripheral surface of the positioning seat unit being located in the clearance space of the at least one locking blocks when the locking unit is in the working position and when the rotary seat is in the locked position.

6. The rotary locking device as claimed in claim 1, wherein the positioning portion of the at least one locking block of the rotary seat extends circumferentially from a top end of the driven portion, the driven portion having a driven surface that extends along the axial direction, the driven surface of the driven portion of the at least one locking block being in contact with the at least one guide inclined surface portion of the positioning seat outer circumferential surface when the locking unit is in the working position and when the rotary seat is in the unlocked position.

7. The rotary locking device as claimed in claim 1, wherein the sliding seat further has at least one sliding block passage that communicates with the at least one sliding seat transverse guide groove and that extends in the axial direction.
